(19) United States
(12) Patent Application Publication
(10) Pub. No.: US 2003/0133557 A1
(43) Pub. Date: Jul. 17, 2003

(54) Method for providing services

(75) Inventor: Dieter Klumpp, Stuttgart (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/339,350

(22) Filed: Jan. 10, 2003

(30) Foreign Application Priority Data
Jan. 11, 2002 (EP) 02360017.4

(51) Int. Cl. H04H 1/00; H04M 3/42

(52) U.S. Cl. 379/207.02; 455/3.01; 379/201.01

(57) ABSTRACT

The invention relates to a method for providing a service in a telecommunications network for a subscriber of the telecommunications network and a service server for carrying out the method. When provision of the service is initiated by subscriber, a subscriber-specific timer is started and provision of the service for the subscriber begins. Provision of the service for subscriber is then terminated on expiry of the subscriber-specific timer assigned to subscriber.

### TECHNICAL FIELD

The invention relates to a method for providing a service in a telecommunications network for a subscriber of the telecommunications network and also a service server for carrying out the method.

The invention is based on a priority application EP 02360017.4 which is hereby incorporated by reference.

The invention is based on provision of services according to IN architecture (IN=Intelligent Network), as described, for example, in the article “Eigenschaften Intelligenter Netze”, Elektrisches Nachrichtenwesen, Vol. 63, no. 4, pages 314 to 319, 1989 by L. Alvarez Mazo et al.

### BACKGROUND OF THE INVENTION

Services are provided in a telecommunications network by means of service switching nodes and service control nodes. Service switching nodes identify when a connection to a service control node is necessary, communicate with the appropriate service control node according to the service and traffic guidance rules, carry out commands of service control nodes and inform them about all events relevant to the connection. The service switching nodes are independent of the type of service provided. The service control nodes contain service programs, in other words the service logics, and the associated data. They control the provision of services by means of access to the service switching nodes.

By means of the service switching nodes and the service control nodes the following services can be supplied, for example: kiosk service, personal telephone number, common telephone number or virtual private network (=VPN). Provision of these services is herein started by a control message from a terminal of the telecommunications network. The kiosk service is in this way provided by the corresponding service control node at a connection request with a service identifier of a kiosk service. Once the service has been provided, service provision is automatically terminated by the service control node. Other services, the “personal telephone number” service, for example, are provided for an unspecified time. Termination of service provision of these services is controlled by means of a service management system.

The object of the invention is to improve the provision of services in telecommunications networks.

This object is achieved by a method for providing a service in a telecommunications network for a subscriber of the telecommunications network wherein a subscriber-specific timer is defined by environmental conditions, user profile or by input at a terminal, the timer is started and provision of the service for the subscriber begins when provision of the service is initiated by subscriber and provision of the service for subscriber is terminated when the subscriber-specific timer assigned to subscriber expires.

This object is further achieved by a service server of a telecommunications network with a service provision unit for providing a service for one or more subscribers of the telecommunications network and with a control unit, which at a control message from a terminal of the telecommunications network starts provision of the service for one of subscribers of the telecommunications network by the service provision unit, wherein the control unit is further configured in such a way that on receipt of the control message it starts a subscriber-specific timer defined by environmental conditions, user profile or by input at a terminal and it terminates provision of a service by the service provision unit for a subscriber of the telecommunications network when the subscriber-specific timer assigned to the subscriber has expired.

The idea behind the invention is to link a service with one or more subscriber-specific timers. Provision of the service for a subscriber is herein terminated when the assigned subscriber-specific timer expires.

The invention brings the advantage that provision of a service can be better matched to the needs of subscribers. Further, the outlay for communications within the telecommunications network is reduced and resources within the telecommunications network are saved.

Advantageous configurations of the invention are to be found in the subordinate claims.

It is advantageous that the subscriber-specific timer forms part of a service logistic of the telecommunications network. This guarantees particularly efficient control of service provision.

It is further advantageous that a service is linked to a plurality of subscriber-specific timers and when one of these timers expires the subscriber to which this subscriber-specific timer is assigned is detected. This further improves the user-friendliness and efficiency of the overall system.

It is further advantageous that the value of subscriber-specific timers is set at subscriber-specific values. This enables provision of services to be particularly well matched to the specific needs of subscribers and user-friendliness thus to be increased.

### BRIEF DESCRIPTION OF THE DRAWINGS

The invention is explained below as an example using several embodiment examples with the aid of the attached drawings.

FIG. 1 shows a block diagram of a telecommunications network with a service server according to the invention for a first embodiment example.

FIG. 2 shows a block diagram of a telecommunications network for a second embodiment example.

### DETAILED DESCRIPTION OF THE DRAWINGS

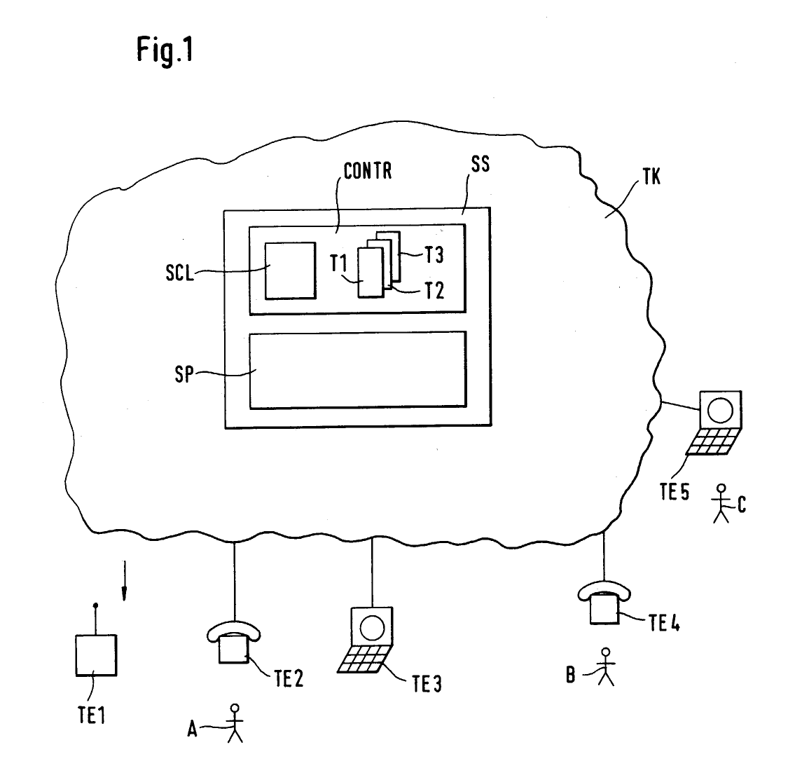

FIG. 1 shows the telecommunications network TK and several terminals TE1 to TE5. Terminals TE1 to TE3 are assigned to a subscriber A. Terminals TE4 and TE5 are assigned to a subscriber B or a subscriber C.

The telecommunications network TK is preferably a telephone network, for example an ISDN network (ISDN=Integrated Services Digital Network). However, it is also possible for the telecommunications network TK to be a communications network acting as speech, data and/or video communication. Therefore the telecommunications network TK can also be a data network which uses the IP protocol (IP=Internet Protocol) as layer 3 protocol. The IP protocol can herein attach to one or more ATM, MAN or Ethernet networks (ATM=Asynchronous Transfer Mode, MAN=Metropolitan Area Network). It is further possible for the telecommunications network TK to consist of several subordinate communications networks. These subordinate communications networks can, for example, be assigned to different network operators or service operators. However, it is also possible for subordinate communications networks of this kind to be communications networks of various kinds. For example, it is possible for the telecommunications network TK to comprise one or more cellular radio networks, for example according to the GSM standard (GSM=Global System for Mobile Communication), one or more fixed networks, for example PSTN networks (PSTN=Public Switched Telecommunication Network) and one or more data networks.

Of the terminals connected to the telecommunications network TK, terminals TE1 to TE5 are shown in FIG. 1 as examples. Terminals TE1 to TE5 are terminals by means of which communication is possible via the telecommunications network TK. Terminal TE1 is a mobile radio terminal operating for example according to the GSM or UMTS standard (UMTS=Universal Mobile Telecommunications System). Terminals TE2 and TE4 are fixed network terminals, for example ISDN telephones. Terminals TE3 and TE5 are computers, equipped with a communication card for communicating via the telecommunications network TK.

As well as one or more network nodes, which enable communication via the telecommunications network TK, the telecommunications network TK comprises one or more service servers. These service servers supply services within the telecommunications network TK to subscribers of the telecommunications network TK. Of the service servers of telecommunications network TK, service server SS is shown in FIG. 1 as an example. It is also possible that the service server SS is not assigned to the network operator of the telecommunications network TK, but to a service operator independent of this.

The service server SS is, for example, a service control node according to IN architecture (IN=Intelligent Network). However, it is also possible for the service server SS to be an internet or WAP server (WAP=Wireless Application Protocol). An internet server makes services available to subscribers of the telecommunications network TK via an IP interface. Advantageously communication between subscribers of the telecommunications network TK and the internet server is herein based via a TCP/IP protocol stack, via which HTML documents and/or Java program codes are exchanged (HTML=Hyper Text Markup Language). WAP servers make services based on the WAP protocol available to subscribers of the telecommunications network TK.

The service server SS supplies one or more services to one or more subscribers of the telecommunications network TK. For example, the service server SS can provide subscribers A, B and C of the telecommunications network TK with one of the following services: forwarding calls, VPN services (VPN Virtual Private Network), UPT services (UPT=Universal Personal Telecommunication), personalization of the user interface, information services, for example regular communication, or communication based on trigger conditions, of stock market data, warning of traffic congestion and similar information or routing services. The service server SS can also provide internet services, for example indication services and news services.

In providing a service in the telecommunications network TK for subscriber A the following method is carried out.

When provision of the service is initiated by subscriber A, a subscriber-specific time is started and then provision of the service for subscriber A begins. When the subscriber-specific timer assigned to subscriber A expires, provision of the service for subscriber A is terminated.

Subscriber A can herein initiate provision of the service by causing one of terminals TE1 to TE3 to send a control message to the service server SS by pressing a special key or choosing a special number. However, it is also possible for subscriber A to initiate provision of the service by dispensing with the sending of a specific control message. It is also possible for initiation to take place via a communication connection between a terminal of the telecommunications network TK and the service server SS, via which a speech signal is transmitted from subscriber A to the service server SS. This speech signal is then evaluated by the service server SS by means of a speech recognition method. Initiation can herein also comprise an authentication or authorization procedure.

The service server SS is formed by one or more computers connected to one another and the software attaching to these computers. By running the software of the service server SS on the hardware of the service server SS the following functions of the service server SS are provided.

From a functional point of view the service server SS provides the functions of a service provision unit SP and the functions of a control unit CONTR.

The service provision unit SP provides a service for one or more subscribers of the telecommunications network TK. The service provision unit SP therefore comprises, for example, an IN service program which controls the provision of one of the above-described services. With more complex services, complex databases and service programs can be assigned to the service provision unit SP.

The control unit CONTR comprises functions which start and terminate provision of the service supplied by the service provision unit or the services supplied by the service provision unit SP for subscribers of the telecommunications network TK. It is herein possible that the software assignable to the control unit CONTR forms an integral component of the software assignable to the service provision unit SP. It is herein advantageous that the control unit CONTR is formed by a program code which forms part of the service program of the service server SS and is thus part of a service logic of the telecommunications network TK.

At a control message from a terminal of the telecommunications network TK the control unit CONTR starts provision of a service for a subscriber of the telecommunications network TK by the service provision unit SP. On receipt of this control message it further starts a subscriber-specific timer.

The control unit CONTR has from a functional point of view a function SCL and one or more timers, of which three timers T1 to T3 are shown in FIG. 1 as examples.

Timers T1 to T3 can be formed by processes which, after a specific time has elapsed, send a trigger message to function SCL or set a flag at a specific value. However, it is also possible for timers T1 to T3 to be hardware timers, supplied for example by an I/O component.

Function SCL receives control messages from terminals of the telecommunications network TK. These control messages can be, for example, MFC signals (MFC=Multi Frequency Code), speech signals or digital signals. It is also herein possible that control messages from terminals of the telecommunications network TK are herein conducted via a network element of the telecommunications network TK which converts or modifies the control messages. For example, a control message from terminal TE1 can be conducted via a service switching node of the telecommunications network TK, which generates an INAP message corresponding to this message (INAP=Intelligent Network Application Protocol) and forwards the INAP message to the service server.

Function SCL now detects whether the received control message should initiate the start of provision of the service or not. The function further detects whether it is authorized to start provision of the service on receipt of this special control message. If this is the case, it starts provision of the service for a subscriber of the telecommunications network TK by the service provision unit SP. This can be implemented, for example, by means of invocation of an appropriate program. In this program invocation, data on the subscriber for whom the service provision unit SP has to provide the service can herein be transferred.

Function SCL further starts a subscriber-specific timer assigned to the subscriber. In this way it generates, for example, a process assigned to the subscriber which provides the function of a subscriber-specific timer. It is, however, also possible for it to select and start a timer, implemented by hardware or software, assigned to the subscriber.

On starting the timer it is herein possible for function SCL to set the timer to a subscriber-individual value. The subscriber-individual value can herein be calculated by function SCL on the basis of environmental condition and a user profile assigned to the subscriber. However, it is also possible for the subscriber-individual value to be transferred to the service server SS from a terminal of the telecommunications network TK.

It is possible, for example, for terminal TE1, at a selection command by subscriber A, to present a window on the display of terminal TE1. In this window a start and an end time for the service to be initiated is presented (default value). These times can then be modified by subscriber A by corresponding control commands. The thus altered start and end times are then communicated to the service server SS by terminal TE1. Function SCL starts the service at the preset start time and sets the user-specific timer to a value corresponding to the preset end time.

The control unit CONTR terminates provision of the service by the service provision unit SP for the subscriber of the telecommunications network when the subscriber-specific timer assigned to the subscriber has expired. Function SCL monitors the course of timers T1 to T3 for this purpose. If during this monitoring it transpires that one of timers T1 to T3 has expired, function SCL detects to which subscriber of the telecommunications network TK the expired timer is assigned and then terminates provision of the service for this subscriber. It is possible for function SCL regularly to detect the timer values of timers T1 to T3 for monitoring. It is also possible that for monitoring it monitors flags assigned to timers T1 to T3 which indicate whether the assigned timer has expired. It is also possible that, on expiry, timers T1 to T3 generate a trigger message and function SCL monitors the receipt of a trigger message of this kind.

The service server SS, as already illustrated above, can be a service control node according to IN architecture. In this case the service provision unit SP provides one or more IN services. It is further possible for the service server SS to be an internet server. In this case the service provision unit SP provides an internet service.

It is further possible for the control unit CONTR and the service provision unit SP to be part of a service logic carried out by a switching center of the telecommunications network TK. A switching center of this kind is preferably a CENTREX switching center. The switching center has the control unit CONTR and the service provision unit SP and this switching center is thus a service server in the sense of the invention.

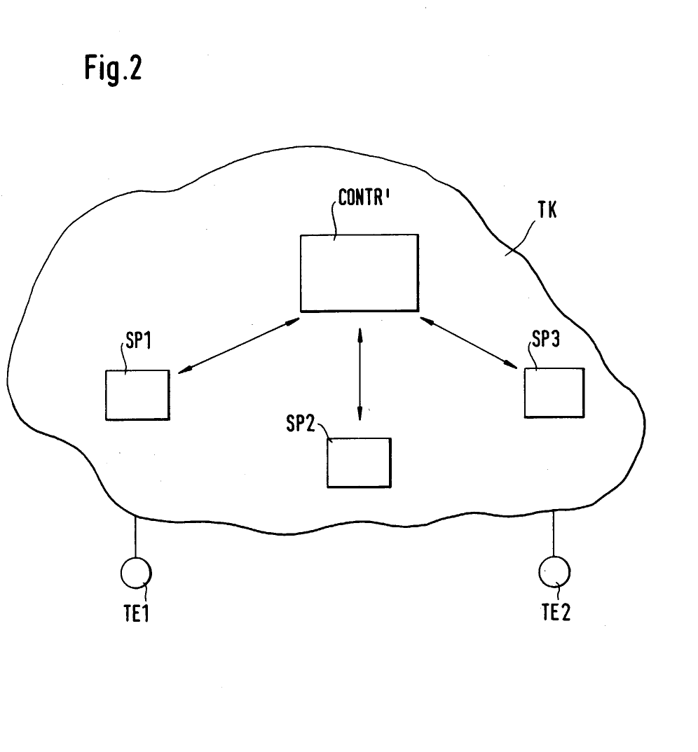

In FIG. 2 a further embodiment example of the invention is explained.

FIG. 2 shows the telecommunications network TK and terminals TE1 and TE2. The telecommunications network TK has the control unit CONTR and three service provision units SP1 to SP3.

In this embodiment example the telecommunications network TK has a virtual service server, formed by a control unit CONTR′ and three spatially separated service provision units SP1 to SP3.

The control unit CONTR′ is formed, for example, by a server of the telecommunications network TK, which provides the functions of the control unit CONTR according to FIG. 1.

The service provision units SP1 to SP3 are spatially distributed in the telecommunications network TK in order to be able to provide the service supplied by them to subscribers of the telecommunications network TK close to their locations. They are formed, for example, by servers of the telecommunications network TK, which in each case provide the functions of the service provision unit SP according to FIG. 1.

On input of the above-described control message the control unit CONTR′ starts provision of the service by one of the service provision units SP1 to SP3. In a data set assigned to the started subscriber-specific timer the control unit CONTR′ herein notes which of the service provision units SP1 to SP3 provides the service for the subscriber. When the subscriber-specific timer assigned to the subscriber has expired, it detects by means of the assigned data set which of the service provision units SP1 to SP3 provides the service for the subscriber. It now sends a control message to this service provision unit, which requests it to terminate provision of the service for the subscriber.

1. Method for providing a service in a telecommunications network for a subscriber of the telecommunications network, wherein a subscriber-specific timer is defined by environmental conditions, user profile or by input at a terminal, the timer is started and provision of the service for the subscriber begins when provision of the service is initiated by subscriber and provision of the service for subscriber is terminated when the subscriber-specific timer assigned to subscriber expires.

2. Method according to claim 1, wherein the service is provided by a service server of the telecommunications network.

3. Method according to claim 1, wherein the service is provided by a service logic carried out by a switching center of the telecommunications network.

4. Method according to claim 1, wherein the subscriber-specific timer forms part of a service logic of the telecommunications network.

5. Service server of a telecommunications network with a service provision unit for providing a service for one or more subscribers of the telecommunications network and with a control unit, which at a control message from a terminal of the telecommunications network starts provision of the service for one of subscribers of the telecommunications network by the service provision unit, wherein the control unit is further configured in such a way that on receipt of the control message it starts a subscriber-specific timer defined by environmental conditions, user profile or by input at a terminal and it terminates provision of a service by the service provision unit for a subscriber of the telecommunications network when the subscriber-specific timer assigned to the subscriber has expired.

6. Service server according to claim 5, wherein the control unit is further configured in such a way that it monitors the course of a multiplicity of subscriber-specific timers defined by environmental conditions, user profile or by input at a terminal and when a subscriber-specific timer expires detects the subscriber assigned to this timer.

7. Service server according to claim 5, wherein the control unit is further configured in such a way that it detects a subscriber-individual value for the subscriber-specific timer and sets the subscriber-specific timer at this value.

8. Service server according to claim 5, wherein the service provision unit is configured in such a way that it provides an IN service.

9. Service server according to claim 5, wherein the service provision unit is configured in such a way that it provides an internet service.
